(19) United States
(12) Patent Application Publication
(10) Pub. No.: US 2024/0362720 A1
(43) Pub. Date: Oct. 31, 2024

(54) EXPENDITURE VISUALIZATION APPLICATION

(71) Applicant: SAP SE, Walldorf (DE)

(72) Inventors: NEHA GARG, Bangalore (IN); Suman Kumar PUTHADI, Bengaluru (IN); Bidisha TRIPATHI, Bangalore (IN); Shwetank MISHRA, Bangalore (IN); Ekta BHARTI, Bengaluru (IN)

(21) Appl. No.: 18/140,134

(22) Filed: Apr. 27, 2023

(51) Int. Cl. G06Q 40/12

(52) U.S. Cl. CPC G06Q 40/12

(57) ABSTRACT

Disclosed herein are system, method and computer program product embodiments for implementing an expenditure visualization application. An embodiment obtains an identifier of a parent cost object, accesses one or more databases of cost accounting data to generate a data structure that represents a hierarchy of cost objects that includes the parent cost object and one or more child cost objects that depend therefrom, the data structure storing planned data and expenditure data for each cost object in the hierarchy, generates based on the data structure a tree view graphical user interface (GUI) control that represents each cost object in the hierarchy of cost objects as a corresponding node, each node in the tree view GUI control including an expenditure visualization representing the planned data and the expenditure data for the corresponding cost object, and provides the tree view GUI control for display via a GUI of the application.

### BACKGROUND

Financial management software applications exists that enable financial transactions of an organization to be recorded for various purposes, including accounting and finance, expense management, risk management, compliance, reporting, analytics, and the like. Such applications may incorporate a cost accounting feature that enables costs to be assigned to cost objects that typically include a company's products, services, and any other entities or activities that involve the company.

### BRIEF DESCRIPTION OF THE DRAWINGS

The accompanying drawings are incorporated herein and form a part of the specification.

FIG. 1 is a block diagram of a system for implementing an expenditure visualization application, according to some embodiments.

FIG. 2 depicts an example graphical user interface (GUI) of an expenditure visualization application, according to some embodiments.

FIG. 3 depicts a further example GUI of an expenditure visualization application, according to some embodiments.

FIG. 4 is a flowchart of a method for implementing an expenditure visualization application, according to some embodiments.

FIG. 5 is a flowchart of a method for providing a waterfall visualization for display via a GUI of an expenditure visualization application, according to some embodiments.

FIG. 6 is a flowchart of a method for providing a line item view for display via a GUI of an expenditure visualization application, according to some embodiments.

FIG. 7 is a flowchart of a method for enabling a user to define one or more user-specific parameters for generating a tree view GUI control of an expenditure visualization application, according to some embodiments.

FIG. 8 is a flowchart of a method for determining one or more parameters for generating a tree view GUI control of an expenditure visualization application, according to some embodiments.

FIG. 9 is a flowchart of a method for providing a trend view for display via a GUI of an expenditure visualization application, according to some embodiments.

FIG. 10 is a flowchart of a method for providing a predictive analysis visualization via a GUI of an expenditure visualization application, according to some embodiments.

FIG. 11 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, financial management software applications exists that enable financial transactions of an organization to be recorded for various purposes, including accounting and finance, expense management, risk management, compliance, reporting, analytics, and the like. Such applications may incorporate a cost accounting feature that enables costs to be assigned to cost objects that typically include a company's products, services, and any other entities or activities that involve the company.

Conventional financial management software applications typically do not provide a mechanism by which to track but the planned allocation and actual expenditure of an organization at different levels (e.g., department and project) in a simple and efficient way. Consequently, it is difficult for users of such applications to obtain true insight into expenditures at each level of the organization.

Such conventional applications also typically do not provide consolidated budget and expenditure information for analyzing organizational spend data and improving strategic sourcing, which can enable reduced expenses throughout the procurement process.

Furthermore, such conventional applications typically do not provide a way to drill down to detailed line item level expenditures from a general department/projects level to enable a deeper cost analysis and save cost/time on performing new analyses. Such conventional applications typically do not provide an easily-understandable visualization of spend versus planned variance for an efficient comparison of data.

Provided herein are system, method and/or computer program product embodiments, and/or combinations and sub-combinations thereof, for implementing an expenditure visualization application that addresses at least some of the foregoing shortcomings of conventional financial management software applications. In embodiments, the expenditure visualization application presents a tree view GUI control that represents a hierarchy of cost objects associated with an organization. The tree view GUI control represents a parent cost object and each child cost object that depends therefrom in the hierarchy of cost objects as a corresponding node, and each node includes an expenditure visualization representing the planned data and the expenditure data (e.g., actuals and commitments) for the corresponding cost object. The application may also generate a waterfall visualization for the parent cost object based on the planned data and the expenditure data associated therewith, wherein the waterfall visualization depicts at least the planned data and the expenditure data for the parent cost object by fiscal period.

In further embodiments, in response to determining that a user has interacted with a particular node of the tree view GUI control, the application generates one or more of: a waterfall visualization for the particular cost object corresponding to the particular node, wherein the waterfall visualization depicts at least the planned data and the expenditure data for the particular cost object by fiscal period; a second tree view GUI control representing the child cost objects in the hierarchy of cost objects that depend from the particular cost object that corresponds to the particular node (which may enable further drilling down to additional levels of detail, e.g., even to a document level); and/or a budget utilization alert corresponding to the particular cost object associated with the particular node.

In still further embodiments, the expenditure visualization application enables a user to define one or more user-specific parameters for generating the tree view GUI control. For example, the user may specify one or more of: an identifier of a parent cost object of interest; one or more filters for determining which cost objects to include in the hierarchy of cost objects; a time period for the expenditure visualizations; a currency (e.g., a source currency or display currency) for the expenditure visualizations; or thresholds for generating budget utilization indicators included in the expenditure visualizations and/or budget utilization alerts.

In further accordance with an embodiment in which the application enables the storing of the aforementioned user-specific parameters, a “circuit breaker pattern” may be utilized in cases where a backend of the application is incapable of retrieving the user-specific parameters at application launch, in which case a set of default parameters are instead utilized to enable the application to nevertheless operate.

In other embodiments, the expenditure visualization application enables a user to obtain a trend view for each cost object in the hierarchy, wherein the trend view includes one or more visualizations that represent planned data and/or expenditure data for the relevant cost object for one or more prior fiscal periods.

In still other embodiments, the expenditure visualization application enables a user to obtain a predictive analysis visualization for each cost object in the hierarchy. The predictive analysis visualization may be generated by performing a predictive analysis for the relevant cost object based on planned data and/or expenditure data for the particular cost object for one or more prior fiscal periods.

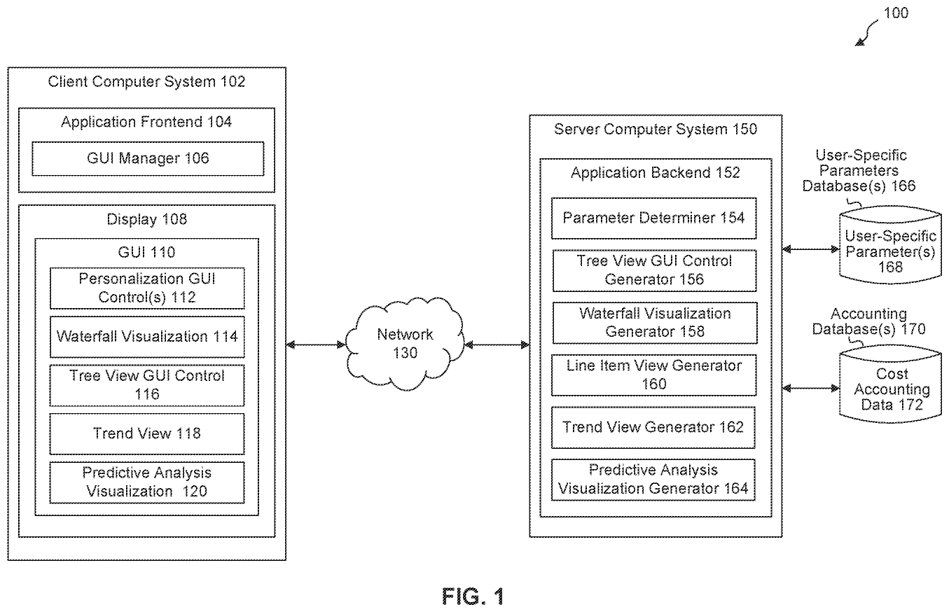

FIG. 1 is a block diagram of a system 100 for implementing an expenditure visualization application in accordance with an embodiment. As shown in FIG. 1, system 100 includes a client computer system 102, a server computer system 150, and a network 130 that communicatively connects client computer system 102 and server computer system 150. Each of these elements will now be described.

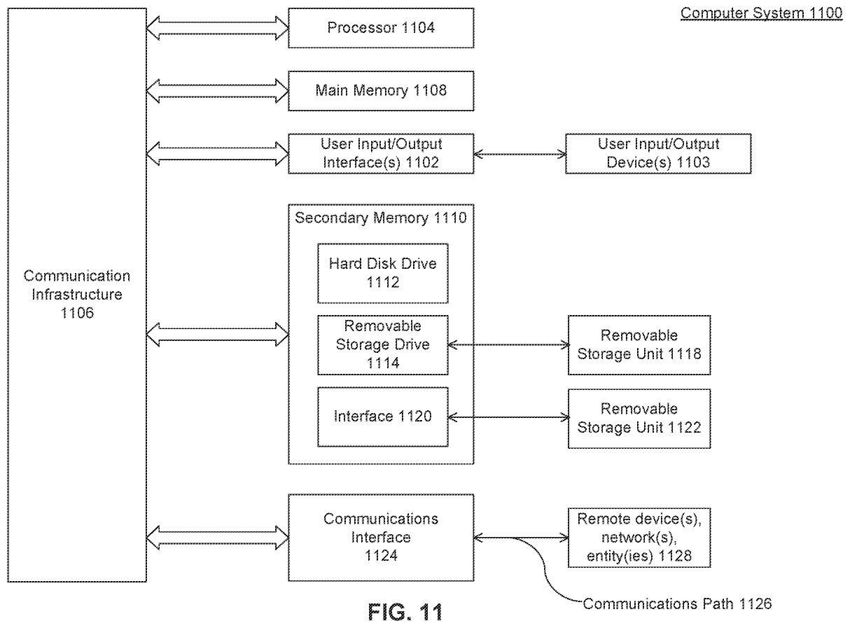

Client computer system 102 is intended to broadly represent any computer system suitable for performing functions that are ascribed thereto in the following description, as will be appreciated by persons skilled in the relevant art(s). One example of such a computer system will be described below in reference to FIG. 11. Client computer system 102 may be embodied in a device with at least one integrated display such as a smart phone, a laptop computer, a notebook computer, a tablet computer, a netbook, an all-in-one desktop computer, a smart television, a wearable device (e.g., virtual/augmented reality headset), or the like. Client computer system 102 may also be implemented by a device, such as a desktop computer or set-top box, which is connected to a suitable display device. However, these are merely examples and are not intended to be limiting

Server computer system 150 is intended to broadly represent any computer system suitable for performing functions that are ascribed thereto in the following description, as will be appreciated by persons skilled in the relevant art(s). One example of such a computer system will be described below in reference to FIG. 11. Server computer system 150 may be implemented by one or more on-premise servers, one or more cloud-based servers, or as a combination of on-premise and cloud-based servers. However, these are merely examples and are not intended to be limiting.

Network 130 may be any communication network suitable for facilitating the exchange of electronic and/or digital communications between client computer system 102 and server computer system 150. In embodiments, network 130 comprise one or more of a local area network (LAN), a wide area network (WAN), a virtual private network (VPN), or a public switched telephone network (PSTN), and may encompass wired and/or wireless portions. Additionally, network 130 may employ any of a variety of communication protocols including but not limited to any of Transmission Control Protocol/Internet Protocol (TCP/IP), Secure Sockets Layer (SSL), and/or Hypertext Transfer Protocol (HTTP).

As further shown in FIG. 1, client computer system 102 comprises an application frontend 104 and a display 124. Application frontend 104 is a component of an expenditure visualization application that comprises both application frontend 104, executed by client computer system 102, and an application backend 152, executed by server computer system 150. Application frontend 104 may be installed on client computer system 102 and executed thereby (e.g., by an operating system of client computer system 102). In an embodiment in which the expenditure visualization application is a Web application, application frontend 104 may be loaded into a Web browser that is running on client computer system 102 and executed thereby.

Display 108 represents any display device suitable for rendering graphical or visual content to a user. Display 108 may be a standalone display device (e.g., a monitor) that is connected to other elements of client computing system 102 via a suitable wired or wireless connection. Alternatively, display 108 may be a display device that is integrated into a housing of another element of client computing system 102 (e.g., an integrated display of a smart phone, laptop computer, or the like).

Application frontend 104 comprises a GUI manager 106. GUI manager 106 is configured to render a GUI 110 associated with the visualization application to display 108 so that a user may view information generated by the application in GUI 110 and interact with the application through various GUI controls presented in GUI 110. In particular, GUI manager 106 is configured to render to GUI 110 one or more personalization GUI controls 112, a waterfall visualization 114, a tree view GUI control 116, a trend view 118 and a predictive analysis visualization 120. These GUI components will be described in more detail herein.

As noted above, server computer system 150 executes application backend 152. Application backend 152 is communicatively coupled to application frontend 104 via network 130. Generally speaking, application backend 152 is configured to perform operations on behalf of application frontend 104 (e.g., in response to application programming interface (API) calls from application frontend 104) to enable various features of the expenditure visualization application. As shown in FIG. 1, application backend 152 comprises a parameter determiner 154, a tree view GUI control generator 156, a waterfall visualization generator 158, a line item view generator 160, a trend view generator 162, and a predictive analysis visualization generator 164. As further shown in FIG. 1, application backend 152 is communicatively connected to one or more user-specific parameters databases 166 and one or more accounting databases 170. Each of these components will be described in more detail herein.

In the following description of the components of FIG. 1, certain operational capabilities will be attributed to application frontend 104 and certain other operational capabilities will be attributed application backend 152. However, as will be appreciated by persons skilled in the relevant art(s), these capabilities may be distributed between application frontend 104 and application backend 152 in a different manner than that described, depending upon the implementation.

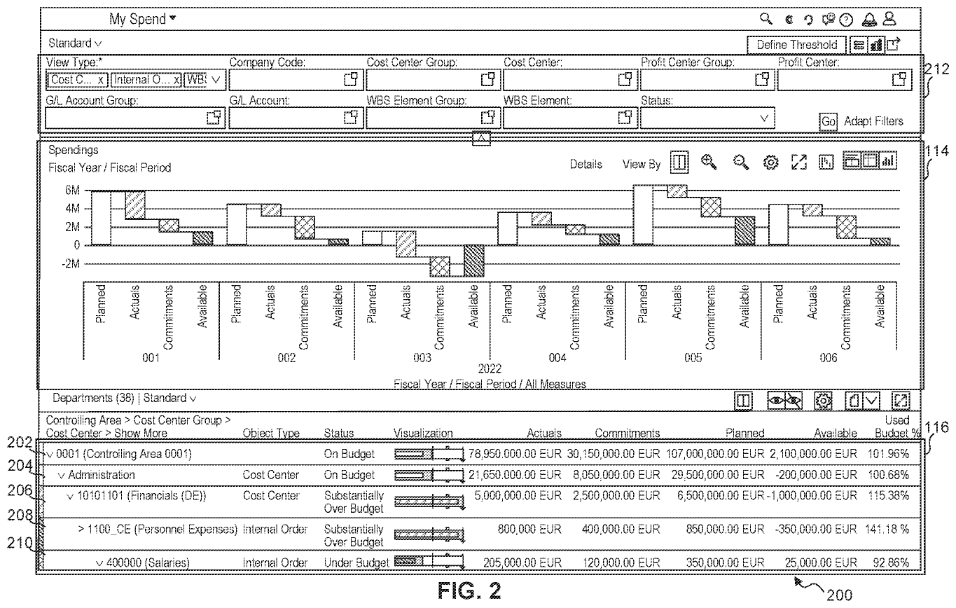

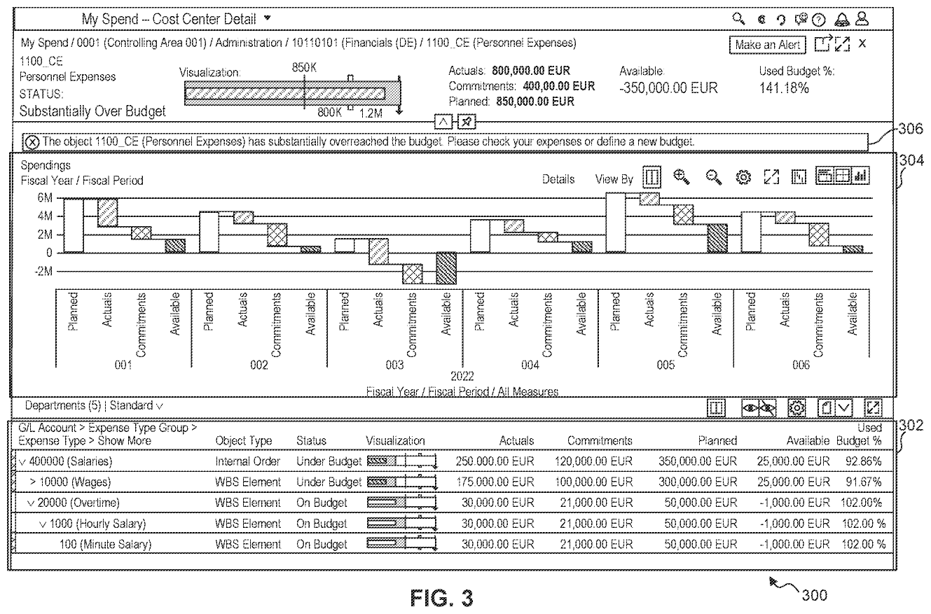

Furthermore, in the following description of the components of FIG. 1, reference will be made to example GUI 200 of FIG. 2 and example GUI 300 of FIG. 3. Each of GUI 200 and GUI 300 may represent a state of GUI 110 during execution of the expenditure visualization application, in accordance with a particular embodiment. However, GUI 200 and GUI 300 are presented merely by way of example only and are by no means limiting.

Tree view GUI control generator 156 is configured to generate tree view GUI control 116 and application backend 152 is configured to provide the same to GUI manager 106 for presentation via GUI 110. Tree view GUI control 116 represents a hierarchy of cost objects associated with an organization. A cost object may represent any entity or item within an organization for which costs may be separately measured. For example, a type of cost object called a “cost center” may be used to represent a department within an organization and a type of cost object called an “internal order” may be used to represent a project carried out by an organization. However, this are merely a few examples. A wide variety of cost object types may be used to represent different entities or items within an organization. Cost objects may be organized in a hierarchy, with child cost objects depending from parent cost objects.

GUI 200 of FIG. 2 shows an example of tree view GUI control 116 in an embodiment in which the relevant cost object hierarchy is (from top to bottom level): controlling area, cost center group, cost center, cost element group, cost element, expense type group, expense type, and expense. However, this is only an example of a cost object hierarchy and is not intended to be limiting.

As shown in FIG. 2, tree view GUI control 116 represents each cost object in the hierarchy as a corresponding node (e.g., line item). Thus, for example, a controlling area named “0001 (Controlling Area 0001)” is represented by a node 202. A cost center group named “Administration” that depends directly from the controlling area named “0001 (Controlling Area 0001)” is represented by a node 204. A cost center named “10101101 (Financials (DE))” that depends directly from the cost center group named “Administration” is represented by a node 206. A cost element group named “1100_CE (Personnel Expenses)” that depends directly from the cost center named “10101101 (Financials (DE))” is represented by a node 208. A cost element named “400000 Salaries” that depends directly from the cost element group named “1100_CE (Personnel Expenses)” is represented by a node 210. In GUI 200, tree view GUI control 116 contains still other nodes that represent other cost objects within the hierarchy; however, these are off screen and may be accessed, for example, using a scroll bar of GUI 200 (not shown in FIG. 2).

In GUI 200, tree view GUI control 116 represents the nested relationship between parent and child nodes through indentation, with each child node being listed beneath and indented relative to its parent node. In an embodiment, each node that is currently visible within tree view GUI control 116 and possesses one or more child nodes may be selectively expanded, so that the child nodes are visible, or collapsed, so that the child nodes are not visible. For example, each visible node may comprise an expander GUI control that a user may interact with to expand or collapse the node.

Each node in tree view GUI control 116 includes an expenditure visualization that represents the planned data and the expenditure data for the cost object that is represented by the node. As used herein the term “visualization” refers to any visible representation of information. In example GUI 200, each node includes the following information: the name of the cost object represented by the node, the type of cost object (if applicable) represented by the node; a budget utilization status for the cost object represented by the node, a planned vs. expenditure visualization for the cost object represented by the node, an actuals amount for the cost object represented by the node, a commitments amount for the cost object represented by the node, a planned amount for the cost object represented by the node, an available amount for the cost object represented by the node, and a budget utilization percentage for the cost object represented by the node. The information shown for each cost object may represent information for a particular time period (e.g., current fiscal year).

In the example of GUI 200, the commitments amount for a cost object may represent expenditures up until the point of invoice receipt for the cost object, the actuals amount for the cost object may represent expenditures after the point of invoice receipt for the cost object, and the sum of these two amounts is the expenditure amount for the cost object. In further accordance with this example, the planned amount is an estimated or budgeted amount for the cost object and the available amount for the cost object is the planned amount for the cost object minus both the actuals amount for the cost object and the commitments amount for the cost object.

In the example of GUI 200, budget utilization (the relationship between the planned amount and the expenditure amount) for each cost object is visualized for the user in a number of ways, beyond listing the actuals, commitments, planned, and available amounts for each cost object.

For example, a budget utilization percentage is shown for each cost object. The budget utilization percentage may be calculated, for example, by dividing the expenditure amount for the cost object by the planned amount for the cost object and multiplying the result by 100.

Furthermore, a budget utilization status is shown for each cost object. In an embodiment, the budget utilization status may be one of: “under budget”, “on budget”, “slightly over budget”, and “substantially over budget”. Each budget utilization status may correspond to a particular range of budget utilization percentages. For example, a budget utilization status of “under budget” may correspond to a budget utilization percentage of less than or equal to 90%, a budget utilization status of “on budget” may correspond to a budget utilization percentage that is greater than 90% and less than or equal to 110%, a budget utilization status of “slightly over budget” may correspond to a budget utilization percentage that is greater than 110% and less than or equal to 150%, and a budget utilization status of “substantially over budget” may correspond to a budget utilization percentage of greater than 150%. However, these are only examples and other ranges may be used to determine the budget utilization status. In an embodiment, a user may customize the range associated with each budget utilization status.

Additionally, a planned vs. expenditure visualization is shown for each cost object. In GUI 200, the planned vs. expenditure visualization is represented by a horizontal bar chart that shows both the actuals amount and the total expenditure amount for the cost object relative to the planned amount for the cost object (represented as a vertical line in the center of the horizontal bar chart), as well as relative to the budget utilization percentage at which the utilization crosses into the “significantly over budget” range (represented as a partial vertical line to the right of the center of the horizontal bar chart).

In still further embodiments, color coding may be used to further visualize the budget utilization for a given cost object in tree view GUI control 116. For example, in GUI 200, one or more of (a) the text used to display the budget utilization status, (b) the bars used to represent the actuals amount and the total expenditure amount in the planned vs. expenditure visualization, and (c) the text used to display the budget utilization percentage may be color coded to visually highlight the current budget utilization status for a given cost object. In accordance with one example color coding scheme, the color green may be used to indicate a budget utilization status of “under budget”, the color gray may be used to indicate a budget utilization status of “on budget”, the color orange may be used to indicate a budget utilization status of “slightly over budget” and the color red may be used to indicate a budget utilization status of “substantially over budget”. In an embodiment, a user may customize the colors that are associated with each budget utilization status.

Tree view GUI control generator 156 is configured to generate tree view GUI control 116 for a cost object of interest. In example GUI 200, the cost object of interest is the controlling area named “0001 (Controlling Area 0001)”. The cost object of interest may be determined based on default parameters or user-specific parameters, and/or based on various user-defined filters that will be described in more detail herein.

In an embodiment, tree view GUI control generator 156 is configured to generate tree view GUI control 116 in the following manner. Application backend 152 obtains an identifier of a parent cost object for which tree view GUI control 116 is to be generated, and passes the identifier to tree view GUI control generator 156. Tree view GUI control generator 156 accesses accounting database(s) 170 that store cost accounting data 172 to generate a data structure that represents a hierarchy of cost objects that includes the parent cost object and one or more child cost objects that depend (e.g., directly and/or indirectly) therefrom. This may entail recursively identifying child cost objects of parent cost objects starting with the original parent cost object until a complete hierarchy is obtained. As part of this process, planned data and expenditure data is obtained from accounting database(s) 170 for various cost objects in the hierarchy. Such data may be summed at a child cost object level to generate corresponding data at a parent cost object level. The data structure stores planned data and expenditure data for each cost object in the hierarchy of cost objects. Based on the data structure generated in this manner, tree view GUI control generator 156 then generates tree view GUI control 116.

Waterfall visualization generator 158 is configured to generate waterfall visualization 114 for the same parent cost object for which tree view GUI control 116 is generated, and application backend 152 is configured to provide the same to GUI manager 106 for presentation via GUI 110. An example of waterfall visualization 114 is shown in GUI 200 of FIG. 2. As shown in GUI 200, waterfall visualization 114 uses a series of bars to show how, for the controlling area named “0001 (Controlling Area”) and for each of a number of fiscal periods that make up a fiscal year, the corresponding planned amount is cumulatively depleted by the corresponding actuals and commitments amounts to produce a corresponding available amount. In an embodiment, waterfall visualization generator 158 leverages the same data structure that is built by tree view UI control generator 156 to generate tree view UI control 116 to build waterfall visualization 114.

As further shown in GUI 200, waterfall visualization 114 may include a label that identifies a fiscal year for which waterfall visualization 114 (and tree view GUI control 116) was generated and a series of labels that identify each fiscal period within the relevant fiscal year. Waterfall visualization 114 may also include a label indicating what each bar represents (e.g., planned, actuals, commitments, and available). In a further embodiment, each bar may be color-coded to correspond to a particular amount (e.g., blue for planned, red for actuals, orange for commitments and green for available).

Each node of tree view GUI control 116 may be interacted with by a user to obtain a line item view associated with the particular cost object represented by the node. For example, each node of tree view GUI control 116 may itself be a GUI control that a user may interact with to obtain a line item view associated with the particular cost object represented by the node. Alternately, each node of tree view GUI control 116 may include a respective line item view GUI control (not shown in FIG. 2 or 3) that a user may interact with to obtain a line item view associated with the particular cost object represented by the node. In either case, GUI manager 106 is configured to detect when a user has interacted with a particular node of tree view GUI control 116 and, in response, notify application backend 152 that the user has interacted with the particular node.

In response to such notification, application backend 152 is configured to activate line item view generator 160. Line item view generator 160 is configured to generate one or more of the following for display via GUI 110 of the expenditure visualization application: a waterfall visualization for the particular cost object corresponding to the particular node; a second tree view GUI control representing the child cost objects in the hierarchy of cost objects that depend (e.g., directly and/or indirectly) from the particular cost object that corresponds to the particular node; or a budget utilization alert corresponding to the particular cost object associated with the particular node.

For example, in response to determining that the user has interacted with node 208 of the example of tree view GUI control 116 shown in FIG. 2, line item view generator 160 may generate an example waterfall visualization 304 shown in FIG. 3 for the “1100_CE Personnel Expenses” cost object corresponding to node 208. As shown in FIG. 3, waterfall visualization 304 depicts the planned data and the expenditure data for the “1100_CE Personnel Expenses” cost object by fiscal periods 001-006 within fiscal year 2022.

As another example, in response to determining that the user has interacted with node 208 of the example of tree view GUI control 116 shown in FIG. 2, line item view generator 160 may generate a second tree view GUI control 302 shown in FIG. 3. Second tree view GUI control 302 represents the child cost objects in the hierarchy of cost objects that depend directly and/or indirectly from the “1100_CE Personnel Expenses” cost object that corresponds to node 208. In an embodiment, each node of second tree view GUI control 302 may be interacted with to obtain a line item view associated with the cost object represented by that node, which may itself include a further tree view GUI control. By enabling the user to continuously explore line item views of nested cost objects in this manner, a user may be enabled to drill down to a lowest level of detail (e.g., to a document level).

As a further example, in response to determining that the user has interacted with node 208 of the example of tree view GUI control 116 shown in FIG. 2, line item view generator 160 may generate budget utilization alert 306 corresponding to the “1100_CE Personnel Expenses” cost object that corresponds to node 208. Budget utilization alerts provide a means for alerting a user to the fact that the budget for a particular cost object has been overreached.

GUI manager 106 is configured to present personalization GUI control(s) 112 to GUI 110. These GUI controls may be interacted with by a user to personalize or otherwise modify certain aspects of the expenditure visualization application. For example, a user may interact with personalization GUI control(s) 112 to define one or more user-specific parameters 168 that are used to generate tree view GUI control 116, waterfall visualization 114, and/or any line views accessed via tree view GUI control 116. These user-specific parameters may be saved in user-specific parameter database(s) 166 and accessed by parameter determiner 154 each time a user launches the application so that such user-specific parameters can be persisted across application sessions.

For example, such user-specific parameters may include the identifier of the parent cost object for which tree view GUI control 116 is to be generated. That is to say, the user may specify a cost object of interest for him/her, such that each time the user accesses the application, that cost object is used as the basis for generating tree view GUI control 116 and waterfall visualization 114.

As another example, such user-specific parameters may include one or more filters for determining which cost objects to include in the hierarchy of cost objects. For example, as shown in FIG. 2, GUI 200 includes a number of filters 212 that a user may interact with to determine which cost objects to include in the hierarchy of cost objects represented by tree view GUI control 116.

As yet another example, such user-specific parameters may include a time period for which budget utilization information is to be obtained for the cost objects. For example, the user may be able to specify a particular fiscal period (e.g., fiscal year) for which budget utilization information is to be obtained.

As still another example, such user-specific parameters may include a currency (e.g., a source currency or a display currency) that should be used to represent the various monetary amounts displayed within tree view GUI control 116, waterfall visualization 114, or within various line item views.

As a further example, such user-specific parameters may include one or more thresholds for generating the aforementioned budget utilization indicators (e.g., the budget status indicator, the lines shown in the planned vs. expenditure bar chart visualization, and the color coding applied to such elements). In a particular example noted above, a user may modify the ranges associated with each budget utilization status (“under budget”, “on budget”, “slightly over budget”, and “substantially over budget”) shown in example GUI 200 and example GUI 300. In an embodiment, such thresholds may also be used to generate budget utilization alerts (e.g., budget utilization alert 306) that may be displayed via GUI 110.

As noted above, parameter determiner 154 may be configured to determine a set of parameters that are used for generating tree view GUI control 116, waterfall visualization 114, a line item view, or the like. In an embodiment, parameter determiner 154 may be configured to perform this function, at least in part, by obtaining user-specific parameter(s) 168 from user-specific parameters database(s) 166 (e.g., at application launch or other time during execution of the application). In further accordance with such an embodiment, if parameter determiner 154 is incapable of retrieving user-specific parameter(s) 168 from user-specific parameters database(s) 166 (e.g., due to a network or server issue), then parameter determine 154 will utilize a set of default parameters instead to enable the application to nevertheless operate.

For example, in response to determining that user-specific parameter(s) 168 cannot be loaded from user-specific parameter database(s) 166, parameter determiner 154 may determine that one or more of the following default parameters will be used for generating tree view GUI control 116, a default parent cost object for which tree view GUI control 116 will be generated, one or more default filters (e.g., filters 214 shown in FIG. 2) for determining which cost objects to include in the hierarchy of cost objects represented by tree view GUI control 116, a default time period for which budget utilization information is to be obtained for the cost objects, a default currency (e.g., a default source currency and/or default display currency) for use in representing the various monetary amounts displayed within tree view GUI control 116 or elsewhere in GUI 110, and/or one or more default thresholds for generating the budget utilization indicators included in tree view GUI control 116 or budget utilization alerts (e.g., budget utilization alert 306).

In an embodiment, GUI manager 106 is configured to provide a trend view GUI control that is displayed within GUI 110 in association with each node of tree view GUI control 116. For example, a trend view GUI control may be included within each node of tree view GUI control 116. Additionally or alternatively, a trend view GUI control may be presented within each line item view corresponding to each node. A user may interact with the trend view GUI control for a particular node to obtain a trend view for the particular cost object represented thereby. GUI manager 106 may notify application backend 152 of such interaction and, in response, trend view generator 162 may generate trend view 118 for the particular cost object. Application backend 152 may provide trend view 118 to GUI manager 106 so that GUI manager 106 can render trend view 118 to GUI 110.

Trend view generator 162 may generate trend view 118 by obtaining planned data and/or expenditure data for the particular cost object for one or more prior fiscal periods from accounting database(s) 170. Trend view 118 may comprise one or more visualizations that represent the planned and/or expenditure data for the particular cost object for the one or more prior fiscal periods. For example, in an embodiment, trend view 118 comprises a series of charts, one for each of a number of prior fiscal years, wherein each chart shows how planned, actuals, commitments, and/or available amounts varied from fiscal period to fiscal period within the relevant fiscal year. However, this is only an example, and trend view 118 may comprise other types of visualizations and information depending upon the implementation. Trend view 118 may advantageously enable a user to identify historical trends with respect to expenditures and use such observations to inform future decision making.

In an embodiment, GUI manager 106 is configured to provide a predictive analysis GUI control that is displayed within GUI 110 in association with each node of tree view GUI control 116. For example, a predictive analysis GUI control may be included within each node of tree view GUI control 116. Additionally or alternatively, a predictive analysis GUI control may be presented within each line item view corresponding to each node. A user may interact with the predictive analysis GUI control for a particular node to obtain a predictive analysis visualization for the particular cost object represented thereby. GUI manager 106 may notify application backend 152 of such interaction and, in response, predictive analysis visualization generator 164 may generate predictive analysis visualization 120 for the particular cost object. Application backend 152 may provide predictive analysis visualization 120 to GUI manager 106 so that GUI manager 106 can render predictive analysis visualization 120 to GUI 110.

Predictive analysis visualization generator 164 may generate predictive analysis visualization 120 by obtaining planned data and/or expenditure data for the particular cost object for one or more prior fiscal periods from accounting database(s) 170, and then conducting a predictive analysis based on such historical data. For example, predictive analysis visualization generator 164 may analyze such historical data to render a budget utilization prediction for a current fiscal period. In an embodiment, the predictive analysis is performed using a supervised or unsupervised machine learning model, the historical data is provided as input to the model, and the budget utilization prediction is provided as an output from the model. However, this is only one example and is not intended to be limiting. The budget utilization prediction generated as a result of the predictive analysis may be embodied in predictive analysis visualization 120. Predictive analysis visualization 120 may also include suggestions for how to best achieve a desired outcome or avoid an undesired outcome. Predictive analysis visualization 120 can advantageously alert a user to a potential issue (e.g., budget deficit) before it happens, thereby enabling the user to take corrective actions to avoid the issue.

In an embodiment, trend view 118 and predictive analysis visualization 120 may be combined into a single view or visualization.

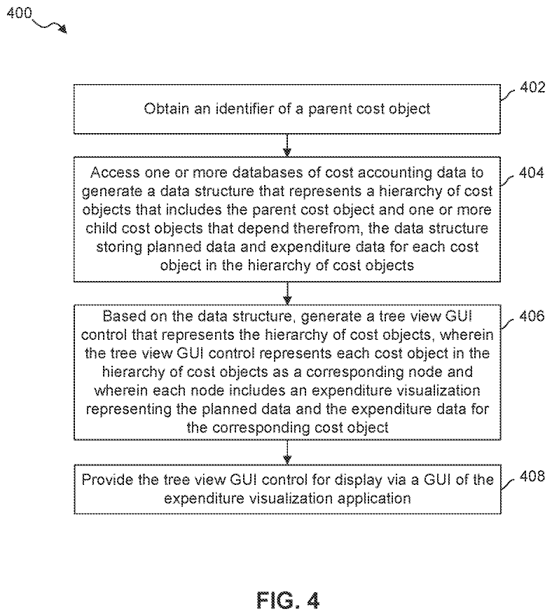

FIG. 4 is a flowchart of a method 400 for implementing an expenditure visualization application, according to an embodiment. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 2. However, method 400 is not limited to those example embodiments.

In 402, application backend 152 obtains an identifier of a parent cost object. Application backend 152 may obtain the identifier based on parameters obtained by parameter determiner 154 (e.g., user-specific parameter(s) 168 that identify a particular cost object of interest to the user, one or more default parameters that specifies a default cost object, or the like). Alternatively, application backend 152 may obtain the identifier of the parent cost object from application frontend 104 (e.g., in response to a user selection or identification of a particular cost object via interaction with filters 212).

In 404, tree view GUI control generator 156 of application backend 152 accesses accounting database(s) 170 that store cost accounting data 172 associated with the organization to generate a data structure that represents a hierarchy of cost objects that includes the parent cost object and one or more child cost objects that depend (e.g., directly and/or indirectly) therefrom. The data structure stores planned data and expenditure data retrieved from accounting database(s) 170 for each cost object in the hierarchy of cost objects.

In 406, based on the data structure generated in step 404, tree view GUI control generator 156 of application backend 152 generates tree view GUI control 116 that represents the hierarchy of cost objects, wherein tree view GUI control 116 represents each cost object in the hierarchy of cost objects as a corresponding node and wherein each node includes an expenditure visualization representing the planned data and the expenditure data for the corresponding cost object. For example, tree view GUI control generator 156 may generate the example of tree view GUI control 116 shown in FIG. 2 that represents cost objects in the hierarchy of cost objects as corresponding nodes 202-210, wherein each of nodes 202-210 includes a corresponding expenditure visualization that represents the planned data and the expenditure data for the corresponding cost object.

In 408, application backend 152 provides tree view GUI control 116 generated by tree view GUI control generator 156 to GUI manager 106 of application frontend 104 for display via GUI 110 of the expenditure visualization application. GUI manager 106 then displays tree view GUI control 116 in GUI 110 which is rendered to display 108 of client computer system 102.

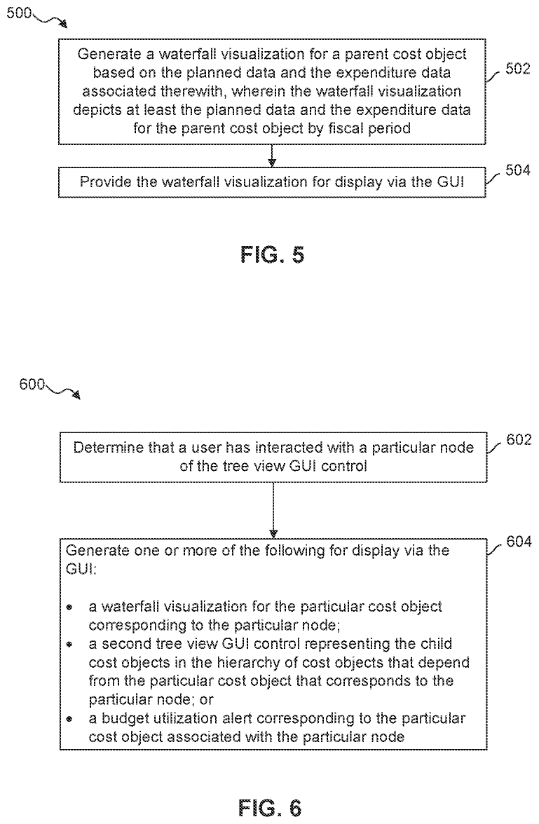

FIG. 5 is a flowchart of a method 500 for providing a waterfall visualization for display via a GUI of an expenditure visualization application, according to an embodiment. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1 and 2. However, method 500 is not limited to those example embodiments.

In 502, waterfall visualization generator 158 of application backend 152 generates waterfall visualization 114 for a parent cost object (e.g., the parent cost object for which an identifier was obtained in step 402 of method 400) based on the planned data and the expenditure data associated therewith (e.g., the planned data and the expenditure data obtained from accounting database(s) 170), wherein waterfall visualization 114 depicts at least the planned data and the expenditure data for the parent cost object by fiscal period. For example, waterfall visualization generator 158 may generate the example of waterfall visualization 114 shown in FIG. 2 that shows the planned data and the expenditure data for the parent cost object designated “0001 (Controlling Area 0001)” by fiscal periods 001-006 of fiscal year 2022.

In 504, application backend 152 provides waterfall visualization 114 generated by waterfall visualization generator 158 to GUI manager 106 of application frontend 104 for display via GUI 110 of the expenditure visualization application. GUI manager 106 then displays waterfall visualization 114 in GUI 110 which is rendered to display 108 of client computer system 102.

FIG. 6 is a flowchart of a method 600 for providing a line item view for display via a GUI of an expenditure visualization application, according to an embodiment. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIGS. 1-3. However, method 600 is not limited to those example embodiments.

In 602, application backend 152 determines that a user has interacted with a particular node of tree view GUI control 116. For example, GUI manager 106 of application frontend 104 may determine that the user has interacted with the particular node of tree view GUI control 116 and, in response, notify application backend 152 that the user has interacted with the particular node.

In 604, in response to determining that the user has interacted with the particular node of tree view GUI control 116, line item view generator 160 generates one or more of the following for display via GUI 110 of the expenditure visualization application: a waterfall visualization for the particular cost object corresponding to the particular node; a second tree view GUI control representing the child cost objects in the hierarchy of cost objects that depend (e.g., directly and/or indirectly) from the particular cost object that corresponds to the particular node; or a budget utilization alert corresponding to the particular cost object associated with the particular node.

For example, in response to determining that the user has interacted with node 208 of the example of tree view GUI control 116 shown in FIG. 2, line item view generator 160 may generate the example waterfall visualization 304 shown in FIG. 3 for the “1100_CE Personnel Expenses” cost object corresponding to node 208. As shown in FIG. 3, waterfall visualization 304 depicts the planned data and the expenditure data for the “1100_CE Personnel Expenses” cost object by fiscal periods 001-006 within fiscal year 2022.

As another example, in response to determining that the user has interacted with node 208 of the example of tree view GUI control 116 shown in FIG. 2, line item view generator 160 may generate second tree view GUI control 302 that represents the child cost objects in the hierarchy of cost objects that depend directly and/or indirectly from the “1100_CE Personnel Expenses” cost object that corresponds to node 208.

As a further example, in response to determining that the user has interacted with node 208 of the example of tree view GUI control 116 shown in FIG. 2, line item view generator 160 may generate budget utilization alert 306 corresponding to the “1100_CE Personnel Expenses” cost object that corresponds to node 208.

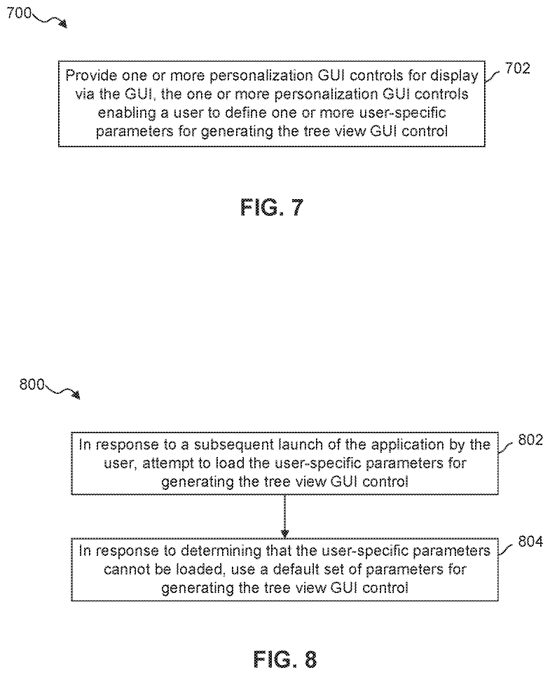

FIG. 7 is a flowchart of a method 700 for enabling a user to define one or more user-specific parameters for generating a tree view GUI control of an expenditure visualization application, according to an embodiment. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIGS. 1-3. However, method 700 is not limited to those example embodiments.

In 702, GUI manager 106 of application frontend 104 provides personalization GUI control(s) 112 for display via GUI 110 of the organizational expenditure visualization application, wherein personalization GUI control(s) 112 enable a user to define user-specific parameter(s) 168 for generating tree view GUI control 116. For example, as previously described, personalization GUI control(s) 112 may enable the user to define (e.g., select or otherwise identify) the identifier of a parent cost object of interest for which tree view GUI control 116 will be generated, one or more filters (e.g., filters 212 shown in FIG. 2) for determining which cost objects to include in the hierarchy of cost objects represented by tree view GUI control 116, a time period (e.g., fiscal year) for the expenditure visualizations included in tree view GUI control 116, a currency (e.g., source currency or display currency) for the expenditure visualizations included in tree view GUI control 116, and/or one or more thresholds for generating certain budget utilization indictors included in the expenditure visualizations or budget utilization alerts (e.g., budget utilization alert 306).

In an embodiment, method 700 further includes storing user-specific parameter(s) 168 in user-specific parameter database(s) 166 for use during subsequent executions of the expenditure visualization application.

FIG. 8 is a flowchart of a method 800 for determining one or more parameters for generating a tree view GUI control of an expenditure visualization application, according to an embodiment. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIGS. 1-3. However, method 800 is not limited to those example embodiments.

In 802, in response to a subsequent launch of the application by the user, parameter determiner 154 of application backend 152 attempts to load user-specific parameter(s) 168 from user-specific parameter database(s) 166 for generating tree view GUI control 116.

In 804, in response to determining that user-specific parameter(s) 168 cannot be loaded from user-specific parameter database(s) 166, parameter determiner 154 determines that a default set of parameters will be used for generating tree view GUI control 116. For example, in response to determining that user-specific parameter(s) 168 cannot be loaded from user-specific parameter database(s) 166, parameter determiner 154 may determine that one or more of the following default parameters will be used for generating tree view GUI control 116: a default parent cost object for which tree view GUI control 116 will be generated, one or more default filters (e.g., filters 212 shown in FIG. 2) for determining which cost objects to include in the hierarchy of cost objects represented by tree view GUI control 116, a default time period for the expenditure visualizations included in tree view GUI control 116, a default currency (e.g., a default source currency and/or default display currency) for the expenditure visualizations included in tree view GUI control 116, and/or one or more default thresholds for generating certain budget utilization indictors included in the expenditure visualizations or budget utilization alerts (e.g., budget utilization alert 306).

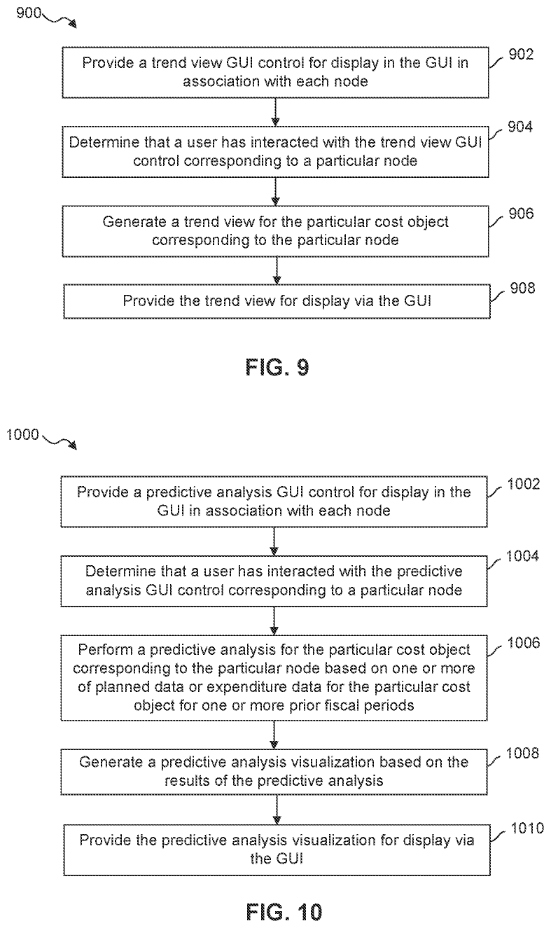

FIG. 9 is a flowchart of a method for providing a trend view for display via a GUI of an organizational expenditure visualization application, according to an embodiment. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art.

Method 900 shall be described with reference to FIG. 1. However, method 900 is not limited to that example embodiment.

In 902, GUI manager 106 of application frontend 104 provides a trend view GUI control for display in GUI 110 in association with each node of tree view GUI control 116.

In 904, application backend 152 determines that a user has interacted with the trend view GUI control corresponding to a particular node.

In 906, in response to determining that the user has interacted with the trend view GUI control corresponding to the particular node, trend view generator 162 generates trend view 118 for the particular cost object corresponding to the particular node.

In 908, application backend provides trend view 118 generated by trend view generator 162 to GUI manager 106 of application frontend 104 for display via GUI 110 of the expenditure visualization application. GUI manager 106 then displays the trend view in GUI 110 which is rendered to display 108 of client computer system 102.

FIG. 10 is a flowchart of a method 1000 for providing a predictive analysis visualization via a GUI of an expenditure visualization application, according to an embodiment. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 1000 shall be described with reference to FIG. 1. However, method 1000 is not limited to that example embodiment.

In 1002, GUI manager 106 of application frontend 104 provides a predictive analysis GUI control for display in GUI 110 in association with each node of tree view control 116.

In 1004, application backend 152 determines that a user has interacted with the predictive analysis GUI control corresponding to a particular node.

In 1006, in response to determining that the user has interacted with the predictive analysis GUI control corresponding to the particular node, predictive analysis visualization generator 164 performs a predictive analysis for the particular cost object corresponding to the particular node based on planned data and expenditure data for the particular cost object for one or more prior fiscal periods. In an embodiment, performing the predictive analysis comprises performing the predictive analysis using a ML model.

In 1008, predictive analysis visualization generator 164 generates predictive analysis visualization 120 based on the results of the predictive analysis of 1006.

In 1010, application backend 152 provides predictive analysis visualization 120 generated by predictive analysis visualization generator 164 to GUI manager 106 of application frontend 104 for display via GUI 110 of the expenditure visualization application. GUI manager 106 then displays predictive analysis visualization 120 in GUI 110 which is rendered to display 108 of client computer system 102.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of removable storage unit 1122 and interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or variable, but every embodiment can not necessarily include the particular feature, structure, or variable. Moreover, such phrases are not necessarily referring to the same embodiment. Further, when a particular feature, structure, or variable is described in connection with an embodiment, it would be within the knowledge of persons skilled in the relevant art(s) to incorporate such feature, structure, or variable into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for implementing an expenditure visualization application, comprising:
obtaining an identifier of a parent cost object;
accessing one or more databases of cost accounting data to generate a data structure that represents a hierarchy of cost objects that includes the parent cost object and one or more child cost objects that depend therefrom, the data structure storing planned data and expenditure data for each cost object in the hierarchy of cost objects;
based on the data structure, generating a tree view graphical user interface (GUI) control that represents the hierarchy of cost objects, wherein the tree view GUI control represents each cost object in the hierarchy of cost objects as a corresponding node and wherein each node includes an expenditure visualization representing the planned data and the expenditure data for the corresponding cost object; and
providing the tree view GUI control for display via a GUI of the expenditure visualization application;
wherein at least one of the obtaining, accessing, generating and providing are performed by one or more computers.

2. The computer-implemented method of claim 1, further comprising:
generating a waterfall visualization for the parent cost object based on the planned data and the expenditure data associated therewith, wherein the waterfall visualization depicts at least the planned data and the expenditure data for the parent cost object by fiscal period; and
providing the waterfall visualization for display via the GUI.

3. The computer-implemented method of claim 1, further comprising:
determining that a user has interacted with a particular node of the tree view GUI control; and
in response to determining that the user has interacted with the particular node of the tree view GUI control, generating one or more of the following for display via the GUI:
a waterfall visualization for the particular cost object corresponding to the particular node, wherein the waterfall visualization depicts at least the planned data and the expenditure data for the particular cost object by fiscal period;
a second tree view GUI control representing the child cost objects in the hierarchy of cost objects that depend from the particular cost object that corresponds to the particular node; or
a budget utilization alert corresponding to the particular cost object associated with the particular node.

4. The computer-implemented method of claim 1, further comprising:
providing one or more personalization GUI controls for display via the GUI, the one or more personalization GUI controls enabling a user to define one or more user-specific parameters for generating the tree view GUI control, the one or more user-specific parameters including one or more of:
the identifier of the parent cost object;
one or more filters for determining which cost objects to include in the hierarchy of cost objects;
a time period for the expenditure visualizations;
a currency for the expenditure visualizations; or
one or more thresholds for generating one or more of budget utilization indicators included in the expenditure visualizations or budget utilization alerts.

5. The computer-implemented method of claim 4, further comprising:
in response to a subsequent launch of the application by the user, attempting to load the one or more user-specific parameters for generating the tree view GUI control; and
in response to determining that the one or more user-specific parameters cannot be loaded, using a default set of parameters for generating the tree view GUI control.

6. The computer-implemented method of claim 1, further comprising:
providing a trend view GUI control for display in the GUI in association with each node;
in response to determining that a user has interacted with the trend view GUI control corresponding to a particular node:
generating a trend view for the particular cost object corresponding to the particular node, the trend view including one or more visualizations that represent one or more of planned data or expenditure data for the particular cost object for one or more prior fiscal periods; and
providing the trend view for display via the GUI.

7. The computer-implemented method of claim 1, further comprising:
providing a predictive analysis GUI control for display in the GUI in association with each node;
in response to determining that a user has interacted with the predictive analysis GUI control corresponding to a particular node:
performing a predictive analysis for the particular cost object corresponding to the particular node based on one or more of planned data or expenditure data for the particular cost object for one or more prior fiscal periods;
based on results of the predictive analysis, generating a predictive analysis visualization; and
providing the predictive analysis visualization for display via the GUI.

8. The computer-implemented method of claim 7, wherein performing the predictive analysis for the particular cost object comprises:
performing the predictive analysis for the particular cost object using a machine learning model.

9. A system for implementing an expenditure visualization application, comprising:
a memory; and
at least one processor coupled to the memory and configured to:
obtain an identifier of a parent cost object;
access one or more databases of cost accounting data to generate a data structure that represents a hierarchy of cost objects that includes the parent cost object and one or more child cost objects that depend therefrom, the data structure storing planned data and expenditure data for each cost object in the hierarchy of cost objects;
based on the data structure, generate a tree view graphical user interface (GUI) control that represents the hierarchy of cost objects, wherein the tree view GUI control represents each cost object in the hierarchy of cost objects as a corresponding node and wherein each node includes an expenditure visualization representing the planned data and the expenditure data for the corresponding cost object; and
provide the tree view GUI control for display via a GUI of the expenditure visualization application.

10. The system of claim 9, the at least one processor further configured to:
generating a waterfall visualization for the parent cost object based on the planned data and the expenditure data associated therewith, wherein the waterfall visualization depicts at least the planned data and the expenditure data for the parent cost object by fiscal period; and
providing the waterfall visualization for display via the GUI.

11. The system of claim 1, the at least one processor further configured to:
determine that a user has interacted with a particular node of the tree view GUI control; and
in response to determining that the user has interacted with the particular node of the tree view GUI control, generate one or more of the following for display via the GUI:
a waterfall visualization for the particular cost object corresponding to the particular node, wherein the waterfall visualization depicts at least the planned data and the expenditure data for the particular cost object by fiscal period;
a second tree view GUI control representing the child cost objects in the hierarchy of cost objects that depend from the particular cost object that corresponds to the particular node; or
a budget utilization alert corresponding to the particular cost object associated with the particular node.

12. The system of claim 9, the at least one processor further configured to:
provide one or more personalization GUI controls for display via the GUI, the one or more personalization GUI controls enabling a user to define one or more user-specific parameters for generating the tree view GUI control, the one or more user-specific parameters including one or more of:
the identifier of the parent cost object;
one or more filters for determining which cost objects to include in the hierarchy of cost objects;
a time period for the expenditure visualizations;
a currency for the expenditure visualizations, or
one or more thresholds for generating one or more of budget utilization indicators included in the expenditure visualizations or budget utilization alerts.

13. The system of claim 12, the at least one processor further configured to:
in response to a subsequent launch of the application by the user, attempt to load the one or more user-specific parameters for generating the tree view GUI control; and
in response to determining that the one or more user-specific parameters cannot be loaded, use a default set of parameters for generating the tree view GUI control.

14. The system of claim 9, the at least one processor further configured to:
provide a trend view GUI control for display in the GUI in association with each node;
in response to determining that a user has interacted with the trend view GUI control corresponding to a particular node:
generate a trend view for the particular cost object corresponding to the particular node, the trend view including one or more visualizations that represent one or more of planned data or expenditure data for the particular cost object for one or more prior fiscal periods; and
provide the trend view for display via the GUI.

15. The system of claim 9, the at least one processor further configured to:
provide a predictive analysis GUI control for display in the GUI in association with each node;
in response to determining that a user has interacted with the predictive analysis GUI control corresponding to a particular node:
perform a predictive analysis for the particular cost object corresponding to the particular node based on one or more of planned data or expenditure data for the particular cost object for one or more prior fiscal periods;
based on results of the predictive analysis, generating a predictive analysis visualization; and
providing the predictive analysis visualization for display via the GUI.

16. The system of claim 15, wherein the at least one processor is configured to perform the predictive analysis for the particular cost object using a machine learning model.

17. A non-transitory computer-readable device having instructions stored thereon that, when executed by at least one computing device, cause the at least one computing device to perform operations for implementing an expenditure visualization application, the operations comprising:
obtaining an identifier of a parent cost object;
accessing one or more databases of cost accounting data to generate a data structure that represents a hierarchy of cost objects that includes the parent cost object and one or more child cost objects that depend therefrom, the data structure storing planned data and expenditure data for each cost object in the hierarchy of cost objects;
based on the data structure, generating a tree view graphical user interface (GUI) control that represents the hierarchy of cost objects, wherein the tree view GUI control represents each cost object in the hierarchy of cost objects as a corresponding node and wherein each node includes an expenditure visualization representing the planned data and the expenditure data for the corresponding cost object; and
providing the tree view GUI control for display via a GUI of the expenditure visualization application.

18. The non-transitory computer-readable device of claim 17, the operations further comprising:
generating a waterfall visualization for the parent cost object based on the planned data and the expenditure data associated therewith, wherein the waterfall visualization depicts at least the planned data and the expenditure data for the parent cost object by fiscal period; and
providing the waterfall visualization for display via the GUI.

19. The non-transitory computer-readable device of claim 17, the operations further comprising:
determining that a user has interacted with a particular node of the tree view GUI control; and
in response to determining that the user has interacted with the particular node of the tree view GUI control, generating one or more of the following for display via the GUI:
a waterfall visualization for the particular cost object corresponding to the particular node, wherein the waterfall visualization depicts at least the planned data and the expenditure data for the particular cost object by fiscal period;
a second tree view GUI control representing the child cost objects in the hierarchy of cost objects that depend from the particular cost object that corresponds to the particular node; or
a budget utilization alert corresponding to the particular cost object associated with the particular node.

20. The non-transitory computer-readable device of claim 17, the operations further comprising:
providing one or more personalization GUI controls for display via the GUI, the one or more personalization GUI controls enabling a user to define one or more user-specific parameters for generating the tree view GUI control, the one or more user-specific parameters including one or more of:
the identifier of the parent cost object;
one or more filters for determining which cost objects to include in the hierarchy of cost objects;
a time period for the expenditure visualizations;
a currency for the expenditure visualizations; or
one or more thresholds for generating one or more of budget utilization indicators included in the expenditure visualizations or budget utilization alerts.
